(19) United States
(12) Patent Application Publication
(10) Pub. No.: US 2021/0192511 A1
(43) Pub. Date: Jun. 24, 2021

(54) SYSTEMS AND METHODS FOR CONFIGURING DATA TRANSFERS

(71) Applicant: The Toronto-Dominion Bank, Toronto (CA)

(72) Inventors: Laird Jerome HERCULES, Barrie (CA); Jonathan David ALMANZA AHUMADA, Toronto (CA); Katherine Ina HEIGHINGTON, Montreal (CA)

(73) Assignee: The Toronto-Dominion Bank, Toronto (CA)

(21) Appl. No.: 16/719,412

(22) Filed: Dec. 18, 2019

(51) Int. Cl. G06Q 20/40; G06F 21/62; H04L 12/58

(52) U.S. Cl. CPC G06Q 20/40; G06F 3/0482; H04L 51/28; G06F 21/62

(57) ABSTRACT

A processor-implemented method is disclosed. The method includes: receiving a first request to configure a recipient database record for receiving one or more electronic data transfers, the first request including identifying information for the recipient database record; receiving a numerical indicator of value to be transferred via a first electronic data transfer to the recipient database record; sending, to a server configured for processing electronic data transfers, a second request to provide, to a transferor entity, an electronic data transfer authorization request, the second request being a request to transfer value to the recipient database record in a first amount corresponding to the numerical indicator of value; receiving, from the server, an indication of authorization for the electronic data transfer from the transferor entity; and increasing a database record value associated with the recipient database record by the first amount.

### TECHNICAL FIELD

The present disclosure relates to data transfers and, in particular, to systems and methods for securely transferring data between database records.

### BACKGROUND

Computing systems can be used to process data from multiple sources. For example, a server may be configured to receive data that is transferred by one or more transferor entities. The received data may be used to, for example, update a database record associated with the server. That is, the server may update a database record based on data that is received from multiple different transferor entities.

When the data from transferor entities vary in types or formats, it may be challenging for a computing system to process the data in a reliable and predictable manner. Further, errors in addressing of the responses can pose security concerns, as the transferred data may be leaked or delivered to a wrong party. It would be advantageous to provide a secure method for a group of transferor entities to send data to a transfer recipient.

### BRIEF DESCRIPTION OF THE DRAWINGS

Reference will now be made, by way of example, to the accompanying drawings which show example embodiments of the present application and in which:

FIG. 1 is a schematic operation diagram illustrating an operating environment of an example embodiment;

FIG. 2 is a high-level schematic diagram of an example computing device;

FIG. 3 shows a simplified organization of software components stored in memory of the example computing device of FIG. 2;

FIG. 4 shows, in flowchart form, an example method for processing requests for electronic data transfers to an intended recipient;

FIG. 5 shows, in flowchart form, an example method for providing user interfaces which enable configuring requests for electronic data transfers to an intended recipient;

FIG. 6 shows, in flowchart form, another example method for processing requests for electronic data transfers to an intended recipient;

FIG. 7 shows an example user interface for configuring an electronic invitation, in accordance with example embodiments of the present disclosure;

FIG. 8 shows an example electronic invitation, in accordance with example embodiments of the present disclosure; and

FIG. 9 shows an example transfer initiation user interface, in accordance with example embodiments of the present disclosure.

Like reference numerals are used in the drawings to denote like elements and features.

### DETAILED DESCRIPTION OF EXAMPLE EMBODIMENTS

In an aspect, the present disclosure describes a computing system. The computing system includes a communications module communicable with an external network, a memory, and a processor coupled to the communications module and the memory. The processor is configured to: receive a first request to configure a recipient database record for receiving one or more electronic data transfers, the first request including identifying information for the recipient database record; receive a numerical indicator of value to be transferred via a first electronic data transfer to the recipient database record; send, to a server configured for processing electronic data transfers, a second request to provide, to a transferor entity, an electronic data transfer authorization request, the second request being a request to transfer value to the recipient database record in a first amount corresponding to the numerical indicator of value; receive, from the server, an indication of authorization for the electronic data transfer from the transferor entity; and increase a database record value associated with the recipient database record by the first amount.

In some implementations, the first request may be received via a first user interface for inputting database record data associated with the recipient database record, and the first user interface may enable input of a first messaging address associated with the transferor entity.

In some implementations, the numerical indicator of value may be received via a second user interface for inputting a desired transfer amount, and the processor may be further configured to send, to the first messaging address, a first message for inviting the transferor entity to initiate the first electronic data transfer to the recipient database record, the first message including an actuatable user interface element for launching the second user interface.

In some implementations, the second user interface may enable input of a second messaging address associated with the transferor entity, and the second request may comprise a request to send, to the second messaging address, the electronic data transfer authorization request.

In some implementations, the first user interface may enable input of a plurality of objective values associated with the recipient database record and the second user interface may enable input of a selection of at least one of the objective values, and the processor may be configured to: receive, via the second user interface, an indication of a selected one of the objective values; and adjust the selected one of the objective values by the first amount.

In some implementations, the first message may comprise a request to respond to a query, and the processor may be configured to receive a response to the query and the numerical indicator of value concurrently.

In some implementations, the server may comprise an electronic funds transfer server, and the second request may comprise an email money transfer request.

In some implementations, the second request may comprise a request to send, to the first messaging address, the electronic data transfer authorization request.

In some implementations, increasing the database record value associated with the recipient database record by the first amount may comprise crediting the recipient database record by the first amount.

In some implementations, the processor may be further configured to: receive a third request to process the electronic data transfer authorization; in response to receiving the third request: authenticate a requesting user to a user database record associated with the transferor entity; and provide a prompt for confirming the electronic data transfer to the recipient database record.

In another aspect, the present disclosure describes a method for processing requests for electronic data transfers. The method includes: receiving a first request to configure a recipient database record for receiving one or more electronic data transfers, the first request including identifying information for the recipient database record; receiving a numerical indicator of value to be transferred via a first electronic data transfer to the recipient database record; sending, to a server configured for processing electronic data transfers, a second request to provide, to a transferor entity, an electronic data transfer authorization request, the second request being a request to transfer value to the recipient database record in a first amount corresponding to the numerical indicator of value; receiving, from the server, an indication of authorization for the electronic data transfer from the transferor entity; and increasing a database record value associated with the recipient database record by the first amount.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

The present application discloses techniques for a group to securely transfer data to a recipient database record. A server may provide a platform for generating requests for data, which can be forwarded to one or more selected parties. The server may, for example, provide a data request configuration interface which allows a user, or recipient, to configure a request to receive electronic data transfers. Together with the configuration of the data request, a selectable option to configure a recipient database record is provided by the server. The recipient database record is directly associated with the data request, and represents a database record that is intended to receive the electronic data transfers which are initiated in response to the data request. The recipient database record may, for example, be a receiving account, such as a bank account, associated with the recipient.

The data request is forwarded to one or more transferor entities. When the data request is accessed by a transferor entity, it includes a selectable option to input data for transfer to the recipient database record. The input data may include a response to a query. The response may, for example, indicate a value to be transferred to the recipient. Specifically, the response may include a numerical indicator of value for transfer to the recipient database record via an electronic data transfer.

In some embodiments of the present disclosure, the data request may be an electronic invitation to an event. The transferor entities may be the event invitees for the event. An electronic invitation that is configured in accordance with present embodiments may include options to input a response to the invitation and a value to transfer to the event host or honored guest, such as an “e-gift”. The electronic invitation may be configured such that transfers of value from event invitees are automatically set up to be directed to a recipient database record (e.g. bank account of the event host/honored guest).

According to embodiments of the present application, the transfer of data from the transferor entities to the recipient leverages use of an intermediary server that is configured for processing electronic data transfers. For example, the intermediary server may be an electronic funds transfer server which facilitates direct transfer of value to recipient database records. When a transferor entity inputs data to be transferred to the recipient, a request is sent to the intermediary server to provide, to the transferor entity, an electronic data transfer authorization request. In particular, the intermediary server is requested to send, to the transferor entity, an authorization request for the transferor entity to authorize the electronic data transfer. Upon receiving an indication of authorization, a secure electronic data transfer to the recipient database record is processed. As the recipient database record is designated at the time of configuring the data request, the transfer of data is made directly to the recipient database record, which may significantly limit the risk of theft or loss of data.

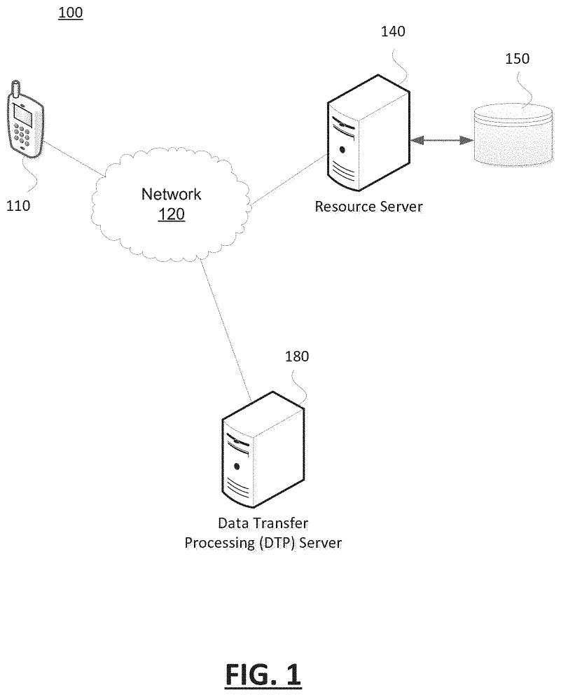

FIG. 1 is a schematic diagram of an exemplary operating environment in accordance with embodiments of the present disclosure. FIG. 1 illustrates exemplary components of a system 100, including one or more client devices 110, a resource server 140, a protected data resource 150, and a data transfer processing (DTP) server 180. The components of system 100 may be configured to provide, in conjunction, various functionalities including, among others, configuring requests to transfer data to a recipient database record, processing the requested data transfers, and updating the recipient database record based on the processed data transfers.

As illustrated, a resource server 140 and client device 110 communicate via the network 120. The client device 110 is a computing device that may be associated with an entity, such as a user or client, having resources associated with the resource server 140 and/or the protected data resource 150. For example, the resource server 140 may track, manage, maintain, and/or lend resources to the entity. The resources may, for example, be computing resources, such as memory or processor cycles. By way of further example, the resources may comprise stored value, such as fiat currency, which may be represented in the protected data resource 150.

The resource server 140 is coupled to the protected data resource 150, which may be provided in secure storage. The secure storage may be provided internally within the resource server 140 or externally. In some embodiments, the secure storage may be provided remotely from the resource server 140. For example, the secure storage may include one or more data centers. The data centers may, for example, store data with bank-grade security.

The protected data resource 150 stores secure data. In particular, the protected data resource 150 may include records for a plurality of accounts associated with various entities. That is, the secure data may comprise account data for one or more specific entities. For example, an entity that operates the client device 110 may be associated with an account having one or more records in the protected data resource 150. In at least some embodiments, the records may reflect a quantity of stored resources that are associated with an entity. Such resources may include owned resources and/or borrowed resources (e.g. resources available on credit). The quantity of resources that are available to or associated with an entity may be reflected by a balance defined in an associated record.

For example, the secure data in the protected data resource 150 may include financial data, such as banking data (e.g. bank balance, historical transactions data identifying transactions such as debits from and credits to an account, etc.) for an entity. In particular, the resource server 140 may be a financial institution (e.g. bank) server and the entity may be a customer of the financial institution which operates the financial institution server. The financial data may, in some embodiments, include processed or computed data such as, for example, an average balance associated with an account, an average spending amount associated with an account, a total spending amount over a period of time, or other data obtained by a processing server based on account data for the entity.

In some embodiments, the protected data resource 150 may be a computer system that includes one or more database servers, computer servers, and the like. In some embodiments, the protected data resource 150 may comprise an application programming interface (API) for a web-based system, operating system, database system, computer hardware, or software library.

The client device 110 may be used, for example, to configure a data transfer from an account at the protected resource 150 that is associated with the client device 110. More particularly, the client device 110 may be used to configure a data transfer from an account associated with an entity operating the client device 110. The data transfer may involve a transfer of data between a record in the protected data resource 150 associated with such an account and another record in the protected data resource 150 (or in another data resource such as a database associated with a different server, not shown, provided by another financial institution, for example). The other record may be associated with a data transfer recipient such as, for example, a bill payment recipient. The data involved in the transfer may, for example, be units of value and the records involved in the data transfer may be adjusted in related or corresponding manners. For example, during a data transfer, a record associated with the data transfer recipient may be adjusted to reflect an increase in value due to the transfer, whereas the record associated with the entity initiating the data transfer may be adjusted to reflect a decrease in value which is at least as large as the increase in value applied to the record associated with the data transfer recipient.

The system 100 includes at least one data transfer processing (DTP) server 180. The DTP server 180 may be associated with a third-party service which facilitates electronic data transfers between two or more different computing systems. For example, the DTP server 180 may itself be configured to receive data from one or more sender (or transferor) entities, and relay the data to one or more intended recipients. The DTP server 180 may process the data prior to forwarding to recipients, e.g. transform the data into different formats, etc., or simply relay the data as-is.

As another example, the DTP server 180 may be configured to process requests for data transfers and instruct one or more remote computing systems to complete the transfers based on the processed requests. The DTP server 180 may, for example, receive a request for a transfer of data from a first database record associated with a first computing system (e.g. a database) to a second database record associated with a second computing system. The first and second computing systems may be associated with entities that are enrolled in an electronic data transfer service administered by the DTP server 180. The service may, for example, be a funds transfer service. The data transfer request may be sent by a transferor associated with the first database record. Upon receiving the data transfer request, the DTP server 180 may generate a message directed to a recipient associated with the second database record that allows the recipient to retrieve the data. For example, the message may include instructions on how to complete the data transfer.

The actual transfer of data between the first and second database records may be completed in various different ways. In some embodiments, the message from the DTP server 180 may contain a link to retrieve the data that is to be transferred. The link may, for example, be a selectable user interface element that is included in the message forwarded by the DTP server 180. The link enables a direct transfer of data to the recipient's database record. In some other embodiments, the data may be transferred indirectly. More specifically, the DTP server 180 may be configured to instruct the first and second computing systems to adjust the data associated with the first and second database records, respectively, in order to execute an indirect transfer of data between the database records. For example, when the recipient completes the steps for retrieving the transferred data, the DTP server 180 may be configured to instruct the first computing system to reduce a value associated with the first database record by the transfer amount and the second computing system to increase a value associated with the second database record by the transfer amount.

In some embodiments, a DTP server may also be configured to generate messages for requesting transfers of data to a recipient. For example, a DTP server may send, to one or more selected entities, a message requesting the entities to transfer certain data to a specific recipient. Such message may, for example, comprise a request (a data transfer authorization request) for a transferor entity to authorize an electronic data transfer to the recipient. A data transfer authorization request may present various options for the transferor entity to authorize and complete a requested data transfer to the recipient. For example, a data transfer authorization request may provide one or more choices of databases (e.g. financial institution databases) from which a selection can be made by the transferor entity based on which database record, i.e. account, is desired to be used for making the requested data transfer.

As illustrated in FIG. 1, the DTP server 180 may be connected to the client device 110 and the resource server 140 via the network 120. The client device 110, the resource server 140, and the DTP server 180 may be in geographically disparate locations. Put differently, the client device 110 may be remote from one or both of the resource server 140 and the DTP server 180.

The client device 110, the resource server 140, and the DTP server 180 are computer systems. The client device 110 may take a variety of forms including, for example, a mobile communication device such as a smartphone, a tablet computer, a wearable computer such as a head-mounted display or smartwatch, a laptop or desktop computer, or a computing device of another type.

The network 120 is a computer network. In some embodiments, the network 120 may be an internetwork such as may be formed of one or more interconnected computer networks. For example, the network 120 may be or may include an Ethernet network, an asynchronous transfer mode (ATM) network, a wireless network, or the like.

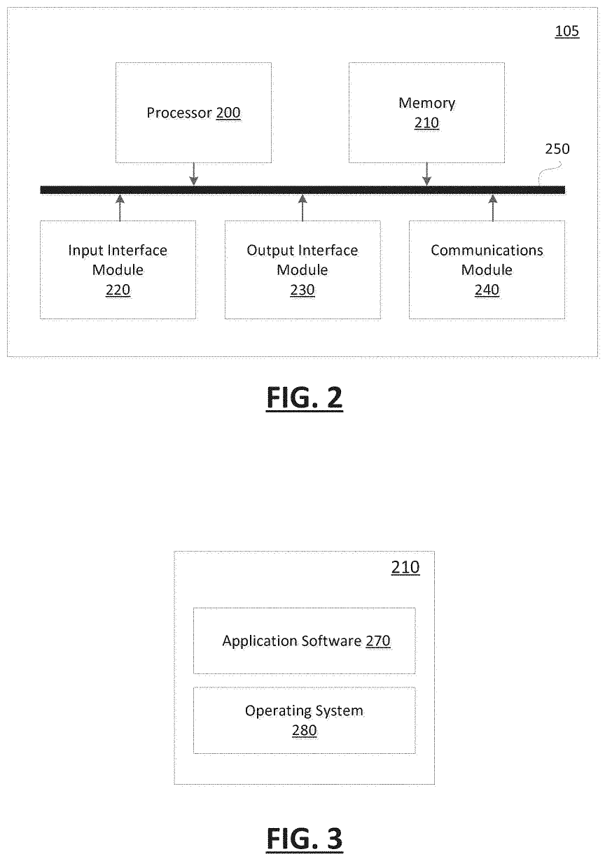

FIG. 2 is a high-level operation diagram of the example computing device 105. In some embodiments, the example computing device 105 may be exemplary of one or more of the client devices 110, the resource server 140, and the third-party DTP server 180. The example computing device 105 includes a variety of modules. For example, as illustrated, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor. The processor 200 may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some embodiments, all or a portion of the input interface module 220 may be integrated with an input device. For example, the input interface module 220 may be integrated with one of the aforementioned exemplary input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by an output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some embodiments, all or a portion of the output interface module 230 may be integrated with an output device. For example, the output interface module 230 may be integrated with one of the aforementioned example output devices.

The communications module 240 allows the example computing device 105 to communicate with other electronic devices and/or various communications networks. For example, the communications module 240 may allow the example computing device 105 to send or receive communications signals. Communications signals may be sent or received according to one or more protocols or according to one or more standards. For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. The communications module 240 may allow the example computing device 105 to communicate using near-field communication (NFC), via Wi-Fi™, using Bluetooth™ or via some combination of one or more networks or protocols. In some embodiments, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 3 depicts a simplified organization of software components stored in memory 210 of the example computing device 105. As illustrated these software components include an operating system 280 and an application 270.

The operating system 280 is software. The operating system 280 allows the application 270 to access the processor 200, the memory 210, the input interface module 220, the output interface module 230 and the communications module 240. The operating system 280 may be, for example, Apple's iOS™, Google's Android™, Linux™, Microsoft's Windows™, or the like.

The application 270 adapts the example computing device 105, in combination with the operating system 280, to operate as a device performing particular functions. For example, the application 270 may cooperate with the operating system 280 to adapt a suitable embodiment of the example computing device 105 to operate as the client device 110, the resource server 140, the application evaluation server 170, and the DTP server(s) 180.

While a single application 270 is illustrated in FIG. 3, in operation, the memory 210 may include more than one application 270, and different applications 270 may perform different operations. For example, in embodiments where the computing device 105 is functioning as a client device 110, the application 270 may comprise a value transfer application which may, for example, be a personal banking application. The value transfer application may be configured for secure communications with the resource server 140 and may provide various banking functions such as, for example, display of account balances, transfers of value (e.g. bill payments, money transfers), and other account management functions.

In some embodiments, the application 270 may comprise an event management application. An event management application may allow users (i.e. event hosts) to create, modify, monitor, and manage various types of events. For example, an event management application may be used to create events, generate and send invitations to events, monitor replies to event invitations, and modify event details. The event management application may provide user interfaces which enable a host to input various event and invitee information. In addition, the event management application may implement a functionality for requesting invitees to transfer certain types of data to the event host. For example, the event management application may provide user interfaces for generating requests for data transfers and configuring a recipient database record for receiving data transfers from the invitees. As will be described below, an event management application may implement functionalities relating to, among others, generating and sending requests for data transfers and configuring a recipient database record for receiving the requested data transfers.

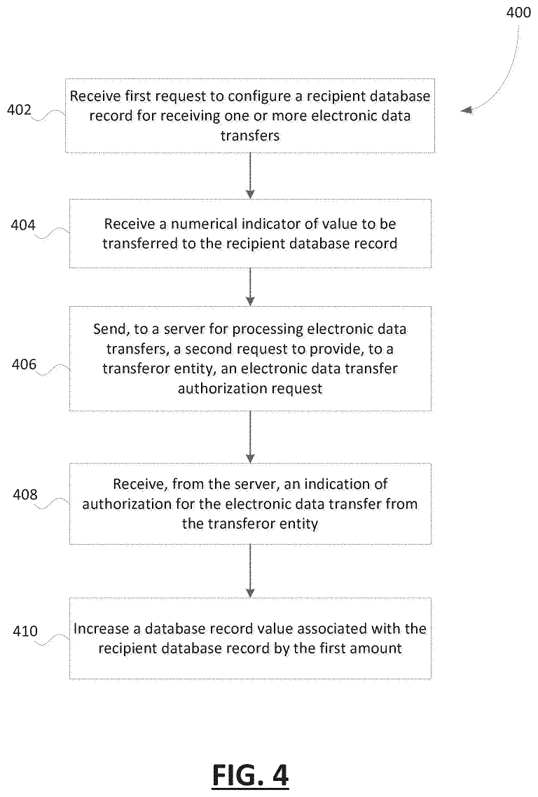

Reference is made to FIG. 4, which shows, in flowchart form, an example method 400 for processing requests for electronic data transfers to an intended recipient. The operations of method 400 may be performed as part of a processor-implemented process for managing an event. For example, the method 400 may be implemented in providing a user interface for configuring event details, generating and sending event invitations, and processing reply data from event invitees.

Operations 402 and onward may be performed by one or more processors of a computing device such as, for example, the processor 200 (FIG. 2) of one or more suitably configured instances of the example computing device 105 (FIG. 2). In at least some embodiments, the method 400 may be performed by a server system. In particular, a server (such as resource server 140) which has access to a protected data resource and which is communicably connected to a client device associated with a user that has an account in the protected data resource may perform all of part of the operations of method 400. In some embodiments, a resource server may perform the operations of method 400 in conjunction with an event management server (e.g. a back-end server associated with an event management platform).

In operation 402, the server receives a first request to configure a recipient database record for receiving one or more electronic data transfers. The server may implement a platform for generating requests for data. For example, the server may provide a user interface for generating an event invitation which may be forwarded to the invitees of an event. The platform may enable a user, or recipient, to select a database record that is intended to receive the electronic data transfers. In the example of an event invitation, the requested data may be responses from the event invitees, such as an RSVP and other data associated with the event. The recipient database record may be a record that is designated by an event host (or honored guest, etc.) for receiving all or part of the data responses from the event invitees.

The first request may be input by a user via the user interface provided by the server. For example, the user interface may enable input of details for the recipient database record associated with an event. The first request includes, at least, identifying information for the recipient database record. The recipient database record may, for example, be a record, or account, in a protected data resource that is associated with an intended recipient of the electronic data transfers. The first request may include the source of the request, an identifier of the protected data resource (e.g. institution number, transit number, etc.), an identifier of the recipient database record (e.g. account number), and identifying information for the recipient (e.g. name, date of birth, etc.). In at least some embodiments, the source of the request may be an event management platform. For example, the first request may be generated when the host of a first event requests, via the event management platform, to configure a recipient database record for receiving transfers of data from one or more invitees of the first event. In particular, the first request may be a request to associate the recipient database record with the first event and any transfers of data associated with the first event.

Upon receiving the first request, the server may perform various steps for configuring the recipient database record to receive electronic data transfers. In some embodiments, the server may maintain a database which stores mappings of events to recipient database records. The database may, for example, contain a listing of events and details of recipient database records that are associated with the respective events. The server may process the first request and create a new entry in the database corresponding to the first event, and the new entry may specify the recipient database record associated with the first event.

Once the recipient database record has been configured, the server may distribute requests for data transfers. In at least some embodiments, the data transfer requests may be included as part of requests to provide responses to a specific query, such as a poll, a survey, or an event invitation. For example, in the context of event management, after the operation 402, the server may forward event invitations, which incorporate a request for transferring data to a host of an event, to invitees of the event. More generally, the server may distribute, to one or more transferor entities, a message inviting the transferor entity to attend an event and to initiate an electronic data transfer to a recipient database record associated with the event.

In operation 404, the server receives, from a transferor entity, a numerical indicator of value to be transferred to the recipient database record that was configured in operation 402. The numerical indicator of value represents a value that is to be transferred to the recipient database record. In at least some embodiments, the server may receive the numerical indicator of value in a response to a request for a data transfer. For example, the numerical indicator of value may be included in a response, provided by a transferor entity, to a query for data (e.g. an event invitation). That is, the numerical indicator of value is provided by a transferor entity, and represents a value that is desired to be transferred to the recipient by the transferor entity.

As explained above, various types of data transfers may leverage use of an intermediary server which facilitates electronic data transfers between two or more computing systems. More specifically, an electronic data transfer from a transferor entity to a recipient may be executed via an intermediary data transfer processing (DTP) server. In operation 406, the server, sends to an intermediary DTP server, a second request to provide, to a transferor entity, an electronic data transfer authorization request. In particular, the second request includes a request to transfer value to the recipient database record in a first amount that corresponds to the numerical indicator of value received in operation 404. The server may provide, as part of the second request, various details of the requested data transfers, to the DTP server. For example, the second request may be an email money transfer request. The second request may indicate the transfer value (i.e. amount corresponding to the numerical indicator of value), identifying information for the pre-configured recipient database record, and contact details, such as messaging addresses, of one or more transferor entities.

In operation 408, the server receives, from the DTP server, an indication of authorization for the electronic data transfer from the transferor entity. The DTP server, which is configured to process electronic data transfers, may send to one or more transferor entities a request to authorize a transfer of value to the recipient database record. In particular, the authorization request may request each transferor entity to authorize a transfer of value in an amount corresponding to the numerical indicator of value that was inputted by the transferor entity. If the transferor entity provides the requested authorization, the DTP server may be configured to inform the server implementing the method 400. For example, the DTP server may send an indication of the transferor entity's authorization for a data transfer.

Upon receiving the indication of authorization for the data transfer, the server can take certain actions. In particular, the server updates the recipient database record, in operation 408. Specifically, the server increases a database record value associated with the recipient database record by the transfer amount of the data transfer from the transferor entity. For example, the server may credit the recipient database record by the transfer amount. This operation presumes that the server maintains and/or has access to the recipient database record, and that the server can cause a change in database record value for the recipient database record. In some embodiments, the server may instruct a second server to increase a value associated with the recipient database record. For example, if the recipient database record is maintained by a second server (e.g. a different bank), a request to adjust the value associated with the recipient database record by a transfer amount may be sent to the second server.

Once a recipient database record is configured for receiving electronic data transfers, it can continually be used for such transfers, without any further input. For example, once a recipient database record is designated for an event, any electronic data transfers associated with the event may be sent to (or used to update) the recipient database record. In particular, transferor entities associated with the event need not specify a database record to which their data is to be transferred.

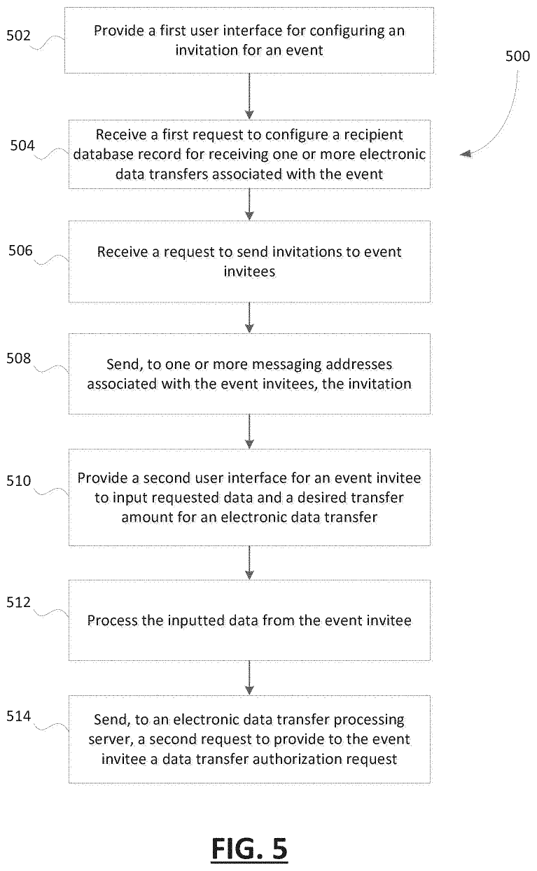

Reference is made to FIG. 5, which shows, in flowchart form, an example method 500 for providing user interfaces which enable configuring requests for electronic data transfers to an intended recipient. The operations of method 500 may be performed by an event management platform or service.

Operations 502 and onward may be performed by one or more processors of a computing device such as, for example, the processor 200 (FIG. 2) of one or more suitably configured instances of the example computing device 105 (FIG. 2). In at least some embodiments, the method 500 may be performed by a server system. In particular, a server (such as resource server 140) which has access to a protected data resource and which is communicably connected to a client device associated with a user that has an account in the protected data resource may perform all of part of the operations of method 500. In some embodiments, a resource server may perform the operations of method 400 in conjunction with an event management server (e.g. a back-end server associated with an event management platform).

In operation 502, the server provides a user interface for configuring an electronic invitation. More specifically, the server provides a first user interface for configuring an invitation for an event. The first user interface is a graphical user interface that is provided for display on a device associated with an event host or honored guest (a “host device”). The first user interface enables an operator of the host device to remotely configure an electronic invitation for an event, such as a wedding.

The first user interface may be provided in response to a request received from the host device. In some embodiments, the request may be a hypertext transfer protocol (HTTP) request, such as an HTTP GET. The request may be issued by a web browser operating on the host device. The web browser may, for example, receive a command through selection of a link or input of an address (e.g. a Uniform Resource Locator) associated with an invitation configuration platform or service. The request may, in other embodiments, be issued by an application other than a web browser. For example, a value transfer application, such as a personal banking application, operating on the host device may issue the request.

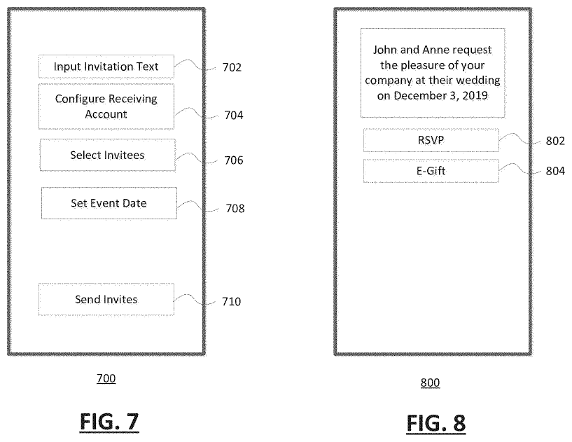

An example invitation configuration interface is illustrated in FIG. 7. As illustrated, the example invitation configuration interface 700 includes a plurality of interface elements which may be used in configuring an electronic invitation. For example, the example invitation configuration interface 700 includes a text field 702 to input text associated with an invitation for an event, a selectable option 708 to specify a date associated with the invitation for the event, a selectable option 704 to configure a receiving account (i.e. recipient database record), a selectable option 706 to define one or more invitees for the event, and a confirmation interface element 710 to send invitees to event invitees. The invitation configuration interface 700 may include other interface elements apart from those illustrated in FIG. 7. Other interface elements may allow, for example, selection of one or more graphics, uploading of photographs, inputting a location of an event, etc.

The various interface elements included in the invitation configuration interface 700 may allow invitation details associated with an event to be defined. For example, a text-based description of the event or an honored guest associated with the event (e.g. the bride(s) and/or groom(s) for a wedding) may be input through interaction with the invitation configuration interface 700. One or more event invitees may also be defined through interaction with the invitation configuration interface 700. For example, a messaging address (e.g. an email address) for each invitee may be inputted, together with a name of the invitee and, in at least some embodiments, other guests (such as significant others, family members, or other guests that are to be included on a common instance of the electronic invitation).

The selectable option 704 for configuring a receiving account may, when selected, cause the host device to prompt for one or more configuration parameters associated with a receiving account. The configuration parameters may include, for example, any one or more of: an account number associated with a bank account, an institution number associated with a bank, a transit number, a swift code, or an alias for any such numbers.

In at least some embodiments, the selectable option 704 to configure a receiving account may be provided within a value transfer application, such as a banking application provided on the host device. For example, the banking application may include value added features, such as the ability to configure electronic invitations. In at least some such embodiments, the selectable option 704 to configure a receiving account may include an option to select an account, from a list of available accounts. For example, the option may allow for selecting between a chequing account and a savings account.

Conveniently, by integrating the electronic invitation features with a banking application, the electronic invitation may be automatically configured with a host (or honored guest) name based on a name that is associated with an active banking account. For example, if the electronic invitation is configured while a user is in a session that was authenticated using credentials for a particular client (e.g. “John Smith”), the server may automatically include the name of the client, “John Smith”, in the electronic invitation.

While the example invitation configuration interface of FIG. 7 illustrates interface elements that are virtual buttons, other types of interface elements may be used instead of or in addition to the interface elements illustrated. For example, the interface elements may include fields, check boxes, radio boxes, buttons, keys, slider bars, etc.

Referring again to FIG. 5, the server receives, through the invitation configuration interface, one or more configuration parameters. The configuration parameters are based on input received at the host device through the invitation configuration interface. For example, the server may receive one or more signals which may represent at least the date associated with the invitation and a messaging address for an invitee. In operation 504, the server receives a first request to configure a recipient database record for receiving one or more electronic data transfers associated with the event. In particular, the server receives a signal which represents a request for a specific database record to be set up to receive electronic data transfers that are initiated by invitees and/or guests of the event. The signal may, for example, represent a selection of a bank account. The signals may be received when the associated selectable options in the invitation configuration user interface are selected and used to input the associated data.

Other data may be received from the host device at the server. For example, invitation data, such as a description of the event, the names of one or more honored guests associated with the event, the location of the event, or other invitation data may be received.

In at least some embodiments, the server may validate at least some of the invitation configuration data received from a host device. For example, authentication may be performed to ensure that the receiving account is associated with a party identified on the invitation. For example, the name of a host (or honored guest) on the invitation may be compared with the name associated with the receiving account to ensure that the names correspond to one another. Such authentication may, for example, reduce the possibility of an attack in which a malicious party sends a fraudulent invitation that has been configured with a receiving account for the malicious party but that purports to be for an event honoring another party. In some embodiments, the name associated with the receiving account may be specified by a configuration parameter for the receiving account and may be received from the host device. In some embodiments, the server may interact with a resource server associated with a protected resource (e.g. a bank database) in order to validate a receiving account. For example, the server may communicate with a third-party bank server to confirm that a name associated with the receiving account specified by the configuration parameters received from the host device corresponds to a name that is configured to be displayed on the electronic invitation. For example, the server may send a message to the bank server asking for confirmation of a name associated with specified account parameters. If the validation fails, the server may issue an error. This error may be communicated to the host device and the electronic invitation may not be sent.

In operation 506, the server receives a request to send invitations to event invitees. For example, the server may receive a signal associated with a selectable option in the invitation configuration interface to send a generated invitation to event invitees. In operation 508, the server sends the electronic invitation to one or more messaging addresses associated with the event invitees. The electronic invitation may, for example, be an email message. In some embodiments, the electronic invitation may be sent within an email message. In some embodiments, a message may be sent that includes a link to the electronic invitation.

An example electronic invitation 800 is illustrated in FIG. 8. The example electronic invitation 800 may be launched and displayed on a device of an invitee (or “transferor device”). The example electronic invitation includes a first interface element 802 for sending an electronic response to the invitation (e.g. to “RSVP”) and a second interface element 804 to transfer value to a pre-defined receiving account (e.g. to “e-gift”).

The first interface element 802 to send an electronic response to the invitation may be selected via interaction with an input module associated with a transferor device to cause a response message to be sent to the server. The response message may include an indication of whether an invitee is attending or not attending an event. The response message may also specify a number of individuals that are contemplated by the response. For example, the response message may indicate the number of guests that will accompany an invitee to the event.

The second interface element 804 may be actuated to initiate a transfer using configuration parameters for the receiving account. In particular, the second interface element 804 may allow an invitee to configure an electronic transfer of value to a host (or honored guest) of the event.

Selection of the second interface element 804 to transfer value may cause the transferor device to prompt for transfer parameters including a quantum of value that is to be transferred. The transfer parameters may also include, for example, credit card or debit card parameters, such as a personal account number (PAN), expiry date, credit card verification (CCV) number, authorization data (such as a password, PIN, security question/answer that is to be used by the host/honoured guest to accept the transfer of value).

In some embodiments, the second interface element 804 to transfer value to the receiving account is configured to cause the transferor device to, in response to receiving selection of the second interface element 804, launch a value transfer application stored on the transferor device. The value transfer application may, for example, be a banking application. If the value transfer application is already operating in an authenticated session, launching the value transfer application may cause the value transfer application to be brought to the foreground. If the value transfer application is not operating in an authenticated session, the value transfer application may prompt for authentication information.

The selection of the second interface element 804 may cause the transferor device to provide the configuration parameters for the receiving account and/or other data (such as a suggested quantum of value and/or date) to the value transfer application. For example, the configuration parameters may be passed to the value transfer application as parameters when the value transfer application is called. By providing such data directly to the value transfer application, the value transfer application may initiate a transfer without requiring input of such information. For example, an account number associated with the host or honoured guest may not need to be manually input since the account number may be automatically input to the value transfer application.

The second interface element 804 may be further configured for automatically configuring a date associated with the transfer with the date associated with the event. For example, the date of the event may be automatically passed to the value transfer application and used as the default date for a transfer of value. Conveniently, the transfer may be automatically configured to occur on the date of the event.

In some other embodiments, actuating the second interface element 804 may cause a second user interface, for configuring a data transfer to the receiving account, to be displayed. For example, the second interface element 804 may be a selectable link for launching a second user interface. Referring back to FIG. 5, in operation 510, the server provides a second user interface for an event invitee to provide a response to the electronic invitation. More specifically, a second user interface is provided for display on a transferor device, allowing the invitee to input requested data (“RSVP”) and/or a desired transfer amount for an electronic data transfer to the recipient database record. The second user interface enables input of various different kinds of information. In at least some embodiments, the second user interface may enable an invitee to input a numerical indicator of value indicating a desired transfer amount, such as in operation 404 of method 400. The numerical indicator of value may, for example, represent a value of a monetary gift that the invitee desires to send to the event host or honored guest. The second user interface may also enable input of a messaging address associated with the invitee. The messaging address may be an email address for the invitee. As will be described below, the messaging address may be used by the server in forwarding an electronic data transfer authorization request to the invitee.

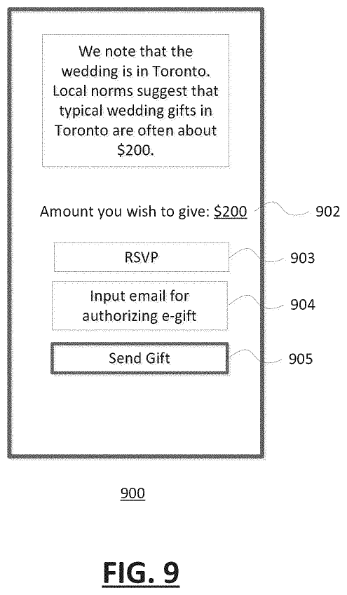

The second user interface may be displayed, for example, after activation of the second interface element 804 in an electronic invitation to an event. A suggested quantum of value may be displayed in the second user interface. An example second user interface 900 is illustrated in FIG. 9. The example second user interface 900 specifies the suggested quantum of value and, in the example, includes a value configuration field 902 for inputting a selected quantum of value. The value configuration field 902 may default to the suggested quantum of value but may be modified through an input module of the recipient device. The example second user interface 900 also includes a reply interface element 903 for providing a response (e.g. “RSVP”) to the event invitation, a text field 904 for inputting a messaging address, and a confirmation interface element 905 for initiating the transfer. The messaging address provided in text field 904 may be used for forwarding an electronic data transfer authorization request to the invitee.

Referring again to FIG. 5, in operation 512, the server processes the inputted data from the event invitee. In particular, the server processes data that is inputted via the second user interface displayed on the transferor device associated with the invitee. The server then sends, to an electronic data transfer processing server, a second request to provide to the invitee a data transfer authorization request, in operation 514. The electronic data transfer processing server may, for example, be an electronic funds transfer processing server. The data transfer authorization request may be sent, by the electronic data transfer processing server, to the messaging address received via the second user interface. That is, the data transfer authorization request may be forwarded to a messaging address that was provided by the invitee, and not to a messaging address which may have been provided by a host (or honored guest) that sent the electronic invitation to the event.

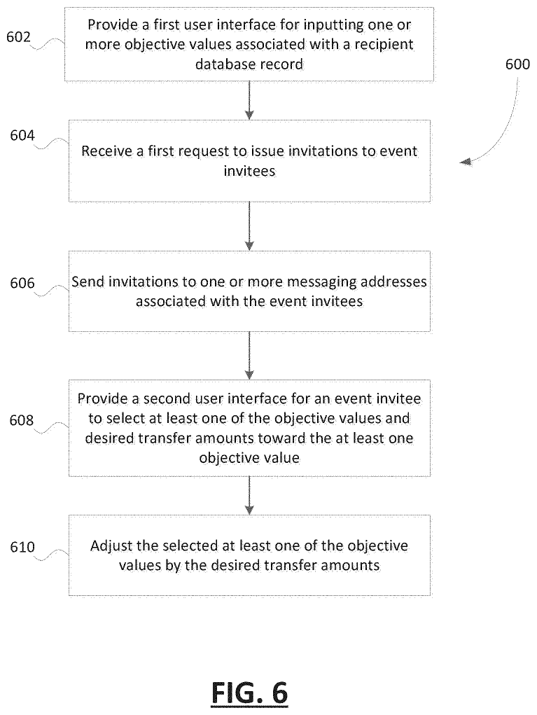

Reference is made to FIG. 6, which shows, in flowchart form, another example method 600 for processing requests for electronic data transfers to an intended recipient. The operations of method 600 may be performed, for example, by an event management platform or service. Operations 602 and onward may be performed by one or more processors of a computing device such as, for example, the processor 200 (FIG. 2) of one or more suitably configured instances of the example computing device 105 (FIG. 2). In at least some embodiments, the method 600 may be performed by a server system, such as a server which has access to a protected data resource and which is communicably connected to a client device associated with a user that has an account in the protected data resource.

In operation 602, the server provides a first user interface for inputting one or more objective values associated with a recipient database record. The first user interface allows an event host or honored guest to configure an electronic invitation to an event. In particular, using the first interface, the host or honored guest can configure parameters of a recipient database record (e.g. bank account) for receiving transfers from event invitees, one or more objectives for the recipient database record, and values associated with the objectives. The objectives may, for example, comprise objectives toward which event invitees can contribute financially. That is, the first user interface allows the host or honored guest to provide one or more options for objectives that an event invitee can select and provide financial contributions to the selected ones of the objectives. In some embodiments, the first user interface may allow for defining a list containing a plurality of different objectives and associated objective values.

In operation 604, the server receives a first request to issue invitations to invitees of the event. For example, the host or honored guest can indicate on the first user interface that the electronic invitation for the event is complete and that the generated invitation should be sent to event invitees. The event invitees and their contact information may, for example, be defined using the first user interface, such that the server can send the electronic invitation to the desired invitees.

In operation 606, the server sends the electronic event invitation to one or more messaging addresses associated with the event invitees. The event invitee may launch the electronic invitation on their device, or transferor device. The electronic invitation may contain, at least, an interface element allowing the event invitee to respond to the invitation and a selectable option to provide an “e-gift”, or transfer of value, to the event host.

In operation 608, the server provides a second user interface, which may be displayed on a transferor device, for responding to the electronic event invitation. In particular, the second user interface allows an event invitee to select at least one of the objective values and desired transfer amounts toward the at least one objective value. The event invitee may select a single objective and input a transfer amount for the selected objective, or select a plurality of objectives and input transfer amounts for the respective selected objectives.

Once the invitee has filled out the response (e.g. by selecting an “RSVP” option, one or more objectives, and transfer amounts to contribute to the respective objectives), the response can be sent to the server from the transferor device. If the server maintains or has access to the recipient database record to which transfers from the event invitees are directed, the server can monitor the various objectives defined by the event host and the transfer amounts contributed to the respective objectives by event invitees. For example, the server may allocate transfer amounts to the different objectives of the event host (or honored guest). In operation 610, the server adjusts the selected at least one of the objective values by the desired transfer amounts inputted by the event invitee. That is, the objective values may be reduced by the desired transfer amounts contributed to the respective values. The server may, for example, credit one or more financial buckets associated with the defined objectives by the transfer amounts. As another example, the server may maintain a historical record of transfers from event invitees, the defined objectives of the event host, and current status of each objective (e.g. whether objective is achieved, how much remaining until objective is achieved, etc.). The tracked objective information may be provided to the host, or an account holder associated with the recipient database record.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing system, comprising:
a communications module communicable with an external network;
a memory; and
a processor coupled to the communications module and the memory, the processor being configured to:
receive a first request to configure a recipient database record for receiving one or more electronic data transfers, the first request including identifying information for the recipient database record;
receive a numerical indicator of value to be transferred via a first electronic data transfer to the recipient database record;
send, to a server configured for processing electronic data transfers, a second request to provide, to a transferor entity, an electronic data transfer authorization request, the second request being a request to transfer value to the recipient database record in a first amount corresponding to the numerical indicator of value;
receive, from the server, an indication of authorization for the electronic data transfer from the transferor entity; and
increase a database record value associated with the recipient database record by the first amount.

2. The computing system of claim 1, wherein the first request is received via a first user interface for inputting database record data associated with the recipient database record, and wherein the first user interface enables input of a first messaging address associated with the transferor entity.

3. The computing system of claim 2, wherein the numerical indicator of value is received via a second user interface for inputting a desired transfer amount, and wherein the processor is further configured to send, to the first messaging address, a first message for inviting the transferor entity to initiate the first electronic data transfer to the recipient database record, the first message including an actuatable user interface element for launching the second user interface.

4. The computing system of claim 3, wherein the second user interface enables input of a second messaging address associated with the transferor entity, and wherein the second request comprises a request to send, to the second messaging address, the electronic data transfer authorization request.

5. The computing system of claim 3, wherein the first user interface enables input of a plurality of objective values associated with the recipient database record and the second user interface enables input of a selection of at least one of the objective values, and wherein the processor is configured to:
receive, via the second user interface, an indication of a selected one of the objective values; and
adjust the selected one of the objective values by the first amount.

6. The computing system of claim 3, wherein the first message comprises a request to respond to a query, and wherein the processor is configured to receive a response to the query and the numerical indicator of value concurrently.

7. The computing system of claim 1, wherein the server comprises an electronic funds transfer server, and wherein the second request comprises an email money transfer request.

8. The computing system of claim 2, wherein the second request comprises a request to send, to the first messaging address, the electronic data transfer authorization request.

9. The computing system of claim 1, wherein increasing the database record value associated with the recipient database record by the first amount comprises crediting the recipient database record by the first amount.

10. The computing system of claim 1, wherein the processor is further configured to:
receive a third request to process the electronic data transfer authorization;
in response to receiving the third request:
authenticate a requesting user to a user database record associated with the transferor entity; and
provide a prompt for confirming the electronic data transfer to the recipient database record.

11. A processor-implemented method, comprising:
receiving a first request to configure a recipient database record for receiving one or more electronic data transfers, the first request including identifying information for the recipient database record;
receiving a numerical indicator of value to be transferred via a first electronic data transfer to the recipient database record;
sending, to a server configured for processing electronic data transfers, a second request to provide, to a transferor entity, an electronic data transfer authorization request, the second request being a request to transfer value to the recipient database record in a first amount corresponding to the numerical indicator of value;
receiving, from the server, an indication of authorization for the electronic data transfer from the transferor entity; and
increasing a database record value associated with the recipient database record by the first amount.

12. The method of claim 11, wherein the first request is received via a first user interface for inputting database record data associated with the recipient database record, and wherein the first user interface enables input of a first messaging address associated with the transferor entity.

13. The method of claim 12, wherein the numerical indicator of value is received via a second user interface for inputting a desired transfer amount, and wherein the method further comprises sending, to the first messaging address, a first message for inviting the transferor entity to initiate the first electronic data transfer to the recipient database record, the first message including an actuatable user interface element for launching the second user interface.

14. The method of claim 13, wherein the second user interface enables input of a second messaging address associated with the transferor entity, and wherein the second request comprises a request to send, to the second messaging address, the electronic data transfer authorization request.

15. The method of claim 13, wherein the first user interface enables input of a plurality of objective values associated with the recipient database record and the second user interface enables input of a selection of at least one of the objective values, and wherein the method further comprises:
receiving, via the second user interface, an indication of a selected one of the objective values; and
adjusting the selected one of the objective values by the first amount.

16. The method of claim 13, wherein the first message comprises a request to respond to a query, and wherein the method further comprises receiving a response to the query and the numerical indicator of value concurrently.

17. The method of claim 11, wherein the server comprises an electronic funds transfer server, and wherein the second request comprises an email money transfer request.

18. The method of claim 12, wherein the second request comprises a request to send, to the first messaging address, the electronic data transfer authorization request.

19. The method of claim 11, wherein increasing the database record value associated with the recipient database record by the first amount comprises crediting the recipient database record by the first amount.

20. The method of claim 11, further comprising:
receiving a third request to process the electronic data transfer authorization;
in response to receiving the third request:
authenticating a requesting user to a user database record associated with the transferor entity; and
providing a prompt for confirming the electronic data transfer to the recipient database record.
